(19) United States
(12) Patent Application Publication
(10) Pub. No.: US 2007/0244326 A1
(43) Pub. Date: Oct. 18, 2007

(54) SELF-INDICATING PHOTO-REPATTERNABLE HYBRID MATERIALS AND POLYMERS

(76) Inventors: Kenneth J. Shea, Irvine, CA (US); Douglas A. Loy, Tucson, AZ (US); Lihua Zhao, Sunnyvale, CA (US)

Correspondence Address: CAROL M. NIELSEN;WINSTEAD PC, 919 MILAM STREET, SUITE 2400, HOUSTON, TX, 77002, US

(21) Appl. No.: 11/690,475

(22) Filed: Mar. 23, 2007

Related U.S. Application Data
(60) Provisional application No. 60/786,566, filed on Mar. 28, 2006.

(51) Int. Cl. C07F 7/02

(52) U.S. Cl. 546/14

(57) ABSTRACT

In some embodiments, the present invention is directed to a method for chemically modifying 7-substituted coumarins to produce polymerizable monomers that are used to prepare photoresponsive materials. In one embodiment, 7-hydroxy-coumarin (umbelliferone) is so modified. The present invention also relates to the photoresponsive linear polymers, copolymers, and hybrid network materials produced from the polymerizable monomers, and the method for their preparation.

### CROSS-REFERENCE TO RELATED APPLICATIONS

The present application claims priority under Title 35, United States Code, § 119 to provisional application U.S. Pat. App. Ser. No. 60/786,566 filed Mar. 28, 2006 and is incorporated herein in its entirety.

### FIELD OF THE INVENTION

The present invention relates generally to a method for chemically modifying 7-substituted coumarins, such as 7-hydroxy-coumarin (umbelliferone), to produce polymerizable monomers that are used to prepare photoresponsive materials. The present invention also relates to the photoresponsive linear polymers, copolymers, and hybrid network materials produced from the polymerizable monomers, and the method for their preparation.

### BACKGROUND INFORMATION

Photoresponsive materials are those with mechanical, electrical and/or optical properties that are modulated by light. Sol-gel derived hybrid materials that covalently integrate photoresponsive groups allow high loading and control of chromophore dispersion with reduction of dye mobility. Advances in photonics are often limited by the availability of multifunctional materials. The properties that determine their utility will depend on the specific application, but important features include low scattering materials that are homogeneous and stable over a wide temperature range [Fuhrmann, T. & Salbeck, J., Organic materials for photonic devices, Mrs. Bull. 28, 354-359 (2003); Homak, L., Polymers for lightwave and integrated optics: technology and applications (New York: M. Dekker, 1992); Innocenzi, P. & Lebeau, B., Organic-inorganic hybrid materials for non-linear optics. J. Mater. Chem. 15, 3821-3831 (2005); Huang, G., Holographic memory, Technol. Rev. 108, 64-67 (2005)]. The ability to create spatially resolved gradients of refractive index in transparent materials is particularly important. Both organic polymers, which are processable and require less powerful lasers, and inorganics, which possess thermal stability, are being employed; but both however have their limitations [Innocenzi, P. & Lebeau, B., Organic-inorganic hybrid materials for non-linear optics, J. Mater. Chem. 15, 3821-3831 (2005); Huang, G., Holographic memory, Technol. Rev. 108, 64-67 (2005); Kagan, C., Mitzi, D., & Dimitrakopoulos, C., Organic-inorganic hybrid materials as semiconducting channels in thin-film field-effect transistors, Science 286, 945-947 (1999)]. Hybrid materials offer the potential to combine many of the desirable properties of both worlds [Schottner, G., Hybrid sol-gel-derived polymers: Applications of multifunctional materials, Chem. Mater. 13, 3422-3435 (2001); Sanchez, C., Julian, B., Belleville, P., & Popall, M., Applications of hybrid organic-inorganic nanocomposites, J. Mater. Chem. 15, 3559-3592 (2005); Shea, K., & Loy, D., Bridged polysilsesquioxanes: Molecular engineering of hybrid organic-inorganic materials, Mrs. Bull. 26, 368-376 (2001); Loy, D. & Shea, K., Bridged Polysilsesquioxanes—Highly Porous Hybrid Organic-Inorganic Materials, Chem. Rev. 95, 1431-1442 (1995)]. Sol-gel derived hybrid materials that covalently integrate photoresponsive groups allow high loading and control of chromophore dispersion with reduction of chromophore mobility.

In view of the foregoing, it would be useful to produce hybrid materials that manifest some or all of the desirable features described above. Here we report new, multiresponsive homogeneous hybrid materials that can be used for writing refractive index and fluorescent patterns. The colorless, transparent, and processable hybrid materials can be used to produce refractive index gratings, “hidden” fluorescent images, and topological features by photopatteming (photolithography). These hybrid materials, which may be prepared by a one step sol-gel polymerization, can be used for fabricating optical circuits, interference filters, waveguides, and media for optical data storage and as part of secure recognition systems. These materials may also be useful in photonics as well as drug delivery and release.

### SUMMARY OF THE INVENTION

In some embodiments, the present invention is directed to photodimers based on 7-substituted coumarins that may optionally be substituted at the 4- and 6-positions. In other embodiments, the present invention is also directed to a 7-silyl substituted coumarin photodimer. In additional aspects, the present invention encompasses compositions of matter produced by the polymerization of photodimers of the present invention and methods for preparation of these compositions.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the UV spectral changes of thin films of syn-ht-coumarin dimer bridged polysilsesquioxane 1X during photoirradiation;

FIGS. 2A-C show fluorescent images produced upon excitation at 350 nm of photopattemed thin films of compound 1X on glass (A), and on silicon wafers (B-C);

FIG. 3A shows a low resolution deltamap characterization of photopattemed thin films of compound 1X on a silicon wafer substrate recorded by imaging ellipsometry;

FIG. 3B shows a high resolution deltamap characterization of photopatterned thin films of compound 1X on a silicon wafer substrate recorded by imaging ellipsometry;

FIG. 3C shows a psi-map characterization of photopatterned thin films of compound 1X on a silicon wafer substrate recorded by imaging ellipsometry;

FIG. 4A shows an ellipsometric contrast image of photopatterned thin films of compound 1X on a silicon wafer substrate;

FIG. 4B shows the spectra of Delta/Psi as a function of wavelength lambda recorded in ROI 1;

FIG. 4C shows the refractive index n in ROI 0; and

FIGS. 5A-F show the refractive index and thickness analysis of a section of the photopatterned compound 1X thin film.

### DETAILED DESCRIPTION OF THE INVENTION

In the following description, specific details are set forth such as specific quantities, sizes, etc. so as to provide a thorough understanding of embodiments of the present invention. However, it will be obvious to those skilled in the art that the present invention may be practiced without such specific details. In many cases, details concerning such considerations and the like have been omitted inasmuch as such details are not necessary to obtain a complete understanding of the present invention and are within the skills of persons of ordinary skill in the relevant art.

In some embodiments, the present invention is directed to thermally robust sol-gel materials derived from a photodimer of 7-hydroxy-coumarin (umbelliferone), a naturally occurring substance found in many families of flowering plants. Coumarins have played an important historical role in photochemistry and serve as valuable laser dyes [Trenor, S., Shultz, A., Love, B., & Long, T., Cumarins in Polymers: From Light Harvesting to Photo-Cross-Linkable Tissue Scaffolds, Chem. Rev. 104, 3059-3077 (2004)]. Coumarin undergoes [2π+2π] photodimerization upon UV irradiation (>300 nm). The photodimer can be cleaved by photolysis at short wavelengths (<300 nm).

Coumarin photodimerization has been studied in homogeneous solution, in organized media, and in polymers [Trenor, S., Shultz, A., Love, B., & Long, T., Cumarins in Polymers: From Light Harvesting to Photo-Cross-Linkable Tissue Scaffolds, Chem. Rev. 104, 3059-3077 (2004); Li, W., Lynch, V., Thompson, H., & Fox, M., Self-Assembled Monolayers of 7-(10-Thiodecoxy)coumarin on Gold: Synthesis, Characterization, and Photodimerization, J. Am. Chem. Soc. 119, 7211-7217 (1997); Gnanaguru, K., Ramasubbu, N., Venkatesan, K., & Ramamurthy, V., A study on the photochemical dimerization of coumarins in the solid state, J. Org. Chem. 50, 2337-46 (1985); Fujiwara, M., Shiokawa, K., Kawasaki, N., & Tanaka, Y. Photodimerization of coumarin-derived pentacyclo[9.5.1.13,9.15,15.17,13]octasiloxane to fabricate a three-dimensional organic-inorganic hybrid material, Adv. Funct. Mater. 13, 371-376 (2003)]. When covalently bound in polymers or inorganic materials, photoinduced dimerization can result in cross-linking. This can produce an increase in molecular weight, modulus and/or access to pores [Fujiwara, M., Shiokawa, K., Kawasaki, N., & Tanaka, Y., Photodimerization of coumarin-derived pentacyclo[9.5.1.13,9.15,15.17,13]octasiloxane to fabricate a three-dimensional organic-inorganic hybrid material, Adv. Funct. Mater. 13, 371-376 (2003); Chen, Y. & Hong, R., Photopolymerization of 7,7′-coumarinyl polymethylene dicarboxylates: Fluorescence and Kinetic Study, J. Polym. Sci. Pol. Chem. 35, 2999-3008 (1997); Mal, N., Fujiwara, M., & Tanaka, Y., Photocontrolled reversible release of guest molecules from coumarin-modified mesoporous silica, Nature 421, 350-353 (2003); Mal, N., Fujiwara, M., Tanaka, Y., Taguchi, T., & Matsukata, M., Photo-Switched Storage and Release of Guest Molecules in the Pore Void of Coumarin-Modified MCM-41, Chem. Mater. 15, 3385-3394 (2003); Schadt, M., Seiberle, H., & Schuster, A., Optical patterning of multidomain liquid-crystal displays with wide viewing angles, Nature 381, 212-215 (1996)]. Photochemical reversibility has also been demonstrated in some cases in polymers bearing pendent coumarin chromophores and when dispersed in a polymer matrix [Schadt, M., Seiberle, H., & Schuster, A., Optical patterning of multidomain liquid-crystal displays with wide viewing angles, Nature 381, 212-215 (1996); Chen, Y. & Chen, K., Synthesis and reversible photocleavage of novel polyurethanes containing coumarin dimer components, J. Polym. Sci., Part A: Polym. Chem. 35, 613-624 (1997); Chen, Y. & Jean, C., Polyethers containing coumarin dimer components in the main chain. II. reversible photocleavage and photopolymerization, J. Appl. Polym. Sci. 64, 1759-1768 (1997); Chen, Y. & Jean, C., Polyethers containing coumarin dimer components in the main chain. I. Synthesis by photopolymerization of 7,7′-(polymethylenedioxy)dicoumarins, J. Appl. Polym. Sci. 64, 1749-1758 (1997); Yuan, X., Fischer, K., & Scharl, W., Reversible cluster formation of colloidal nanospheres by interparticle photodimerization, Adv. Funct. Mater. 14, 457-463 (2004)]. The incorporation of coumarin photodimers as structural units in polymers and network materials would provide for photoinduced bond cleavage that could also be used to alter the physical, optical, and mechanical properties of the material. Photoinduced bond cleavage would decrease moduli, lower molecular weight as well as alter the porosity of network materials.

There are however, few reports of coumarin photodimers used as building blocks for polymers or materials [Chen, Y. & Chen, K., Synthesis and reversible photocleavage of novel polyurethanes containing coumarin dimer components, J. Polym. Sci., Part A: Polym. Chem. 35, 613-624 (1997); Saigo, K., Nakamura, M., Suzuki, Y., Fang, L., & Hasegawa, M., Synthesis and Properties of Polyamides Having Anti Head-to-Head Umbelliferone Dimer as a Component. Macromolecules 23, 3722-3729 (1990); Saigo, K. et al., Optically-Active Polyamides Consisting of Anti Head-to-Head Coumarin Dimer and Alpha,Omega-Alkanediamine—Odd Even Discrimination in Chiral Recognition Ability Depending on the Methylene Number of the Diamine Component and Correlation between the Ability and Crystallizability, Macromolecules 23, 2830-2836 (1990)]. Reasons for this can be attributed to synthetic difficulties and the chemical instability of known photodimers, which are reported to decompose in the presence of acid, base, and other reagents, rendering them incompatible with many polymerization conditions [Saigo, K., Nakamura, M., Suzuki, Y., Fang, L., & Hasegawa, M., Synthesis and Properties of Polyamides Having Anti Head-to-Head Umbelliferone Dimer as a Component. Macromolecules 23, 3722-3729 (1990); Yu, X., Scheller, D., Rademacher, O., & Wolff, T., Selectivity in the Photodimerization of 6-Alkylcoumarins, J. Org. Chem. 68, 7386-7399 (2003)]. Upon surveying isomeric photodimers of 7-alkyloxycoumarin, we have found that the syn-head-to-tail (syn-ht) isomer (see Scheme 1, below) has considerable chemical stability permitting its conversion to functional monomers.

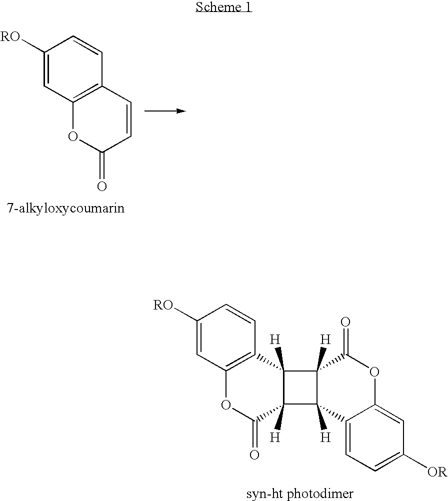

In an embodiment, the syn-ht-7-allyloxycoumarin photodimer (Scheme 1, R═H₂C═CH—CH₂—) was obtained from Lewis acid-catalyzed (BF₃-OEt₂) photodimerization of 7-allyloxycoumar synthesized from 7-hydroxycoumarin (Scheme 1, R═H) and allyl bromide in the presence of potassium carbonate. However, the invention is not limited to the allyloxy derivative, and the OR group may generally comprise, but is not limited to, acetoxy, alkyloxy, methacryloyloxy, and other polymerizable derivatives. Specifically, R may comprise H or CR₁R₂R₃, wherein R₁, R₂, and R₃ may comprise, independently, substituents including, but not limited to, H, cyclic or acyclic, substituted or unsubstituted, alkyl or aryl (or wherein the combination of R₁ and R₂ represents a substituted or unsubstituted alkene or imine, or a cyclic moiety, or wherein the combination of R₁, R₂, and R₃ represents cyanide, an alkyne, or a bi-cyclic moiety), NR₄R₅ (wherein R₄ and R₅ may comprise, independently, substituents including, but not limited to, H, cyclic or acyclic, substituted or unsubstituted, alkyl or aryl, (or wherein the combination of R₄ and R₅ represents a cyclic moiety or a substituent double-bonded to N), and OR₆, (wherein R₆ may comprise substituents including, but not limited to, H, cyclic or acyclic, substituted or unsubstituted, alkyl or aryl). Additionally, while boron trifluoride etherate (BF₃—OEt₂) was employed above as the Lewis acid catalyst, other Lewis acids, including but not limited to, Et₂AlCl, SnCl₄, HgCl₂, and organo boranes may be utilized.

In addition, the coumarins useful in practicing the present invention may contain additional substitution. Coumarins useful in practicing the present invention include, but are not limited to, 4- and/or 6-substituted coumarins (as shown below), wherein R₇ and R₈ may comprise, independently, substituents including, but not limited to, halogen; NR₉R₁₀ (wherein R₉ and R₁₀ may comprise, independently, substituents including, but not limited to, H, cyclic or acyclic, substituted or unsubstituted, alkyl or aryl, (or wherein the combination of R₉ and R₁₀ represents a cyclic moiety or a substituent double-bonded to N); OR₁₁, (wherein R₁₁ may comprise substituents including, but not limited to, H, cyclic or acyclic, substituted or unsubstituted, alkyl or aryl); and the same substituents as described above for R.

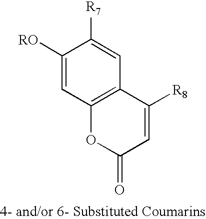

For material synthesis, the syn-ht-7-allyloxycoumarin photodimer (Scheme 1, R═H₂C═CH—CH₂—) was elaborated to a sol-gel processable monomer, the bis-triethoxysilyl derivative 1, by hydrosilylation, as shown in Scheme 2, below.

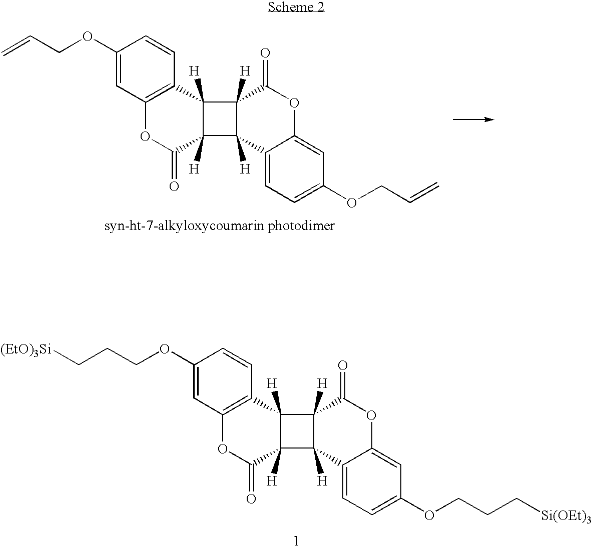

In an embodiment, 0.202 g (0.5 mmol) of the syn-head-to-tail-7-allyloxycoumarin dimer was added to a flask with benzene (1.2 mL) under nitrogen at room temperature. After homogenization of the resulting mixture, triethoxysilane (0.198 mg, 1.2 mmol) was added to the mixture, followed by addition of platinum(0)-1,3-divinyl-1,1,3,3-tetramethyldisiloxane complex solution in xylenes (3% by weight, 10 μL) as catalyst. The resulting mixture was stirred at 50° C. overnight. After the reaction mixture was cooled down to room temperature, benzene (˜5 mL) was added. The solution was then quickly passed through a silica gel column for filtration. The filtrate was reduced under vacuum (30 mmHg) to remove solvents and low boiling point contaminants. The residue was dried under high vacuum (10 mtorr) overnight to give the product monomer 1, syn-head-to-tail-7-(3-triethoxysilyl)propyloxycoumarin dimer (0.317 g, 87%).

While a triethoxysilyl derivative is described above, the invention is not so limited, and other polymerizable substituents may be employed. Useful silicon containing groups other than triethoxysilane include, but are not limited to, SiXₙR′ₘ, wherein n represents an integer from 1 to 3, and m represents an integer from 0 to 2, wherein n+m=3, and wherein X comprises substituents selected independently from halogen, polymerizable unsaturated carbon-containing unit, i.e., containing one or more non-aromatic sp² or sp hybridized carbons (such as vinyl, allyl, methacryl, a-halo carbonyl, imino, cyano, etc.), and OR″, wherein R″ comprises H and cyclic or acyclic, substituted or unsubstituted, alkyl or aryl (or wherein the combination of two X substituents represents a cyclic moiety, or wherein the combination of three X substituents represents a bi-cyclic moiety); wherein R′ comprises substituents selected independently from H and cyclic or acyclic, substituted or unsubstituted, alkyl or aryl (or wherein the combination of two R′ substituents or the combination of R′ and OR″ represents a cyclic moiety, or wherein the combination of two R′ substituents and OR″ or the combination of R′ and 2 OR″ substituents represents a bi-cyclic moiety). Specific silicon-containing examples include, but are not limited to, dimethylethoxysilane, diethoxymethylsilane, oligo-dimethylsilane, and polydimethylsilane (PDMS).

A syn-ht-photodimer (or derivative thereof) of the present invention, such as Monomer 1, may be polymerized to a monolith, thin film, fiber or powder using, for example, sol-gel chemistry (Scheme 3).

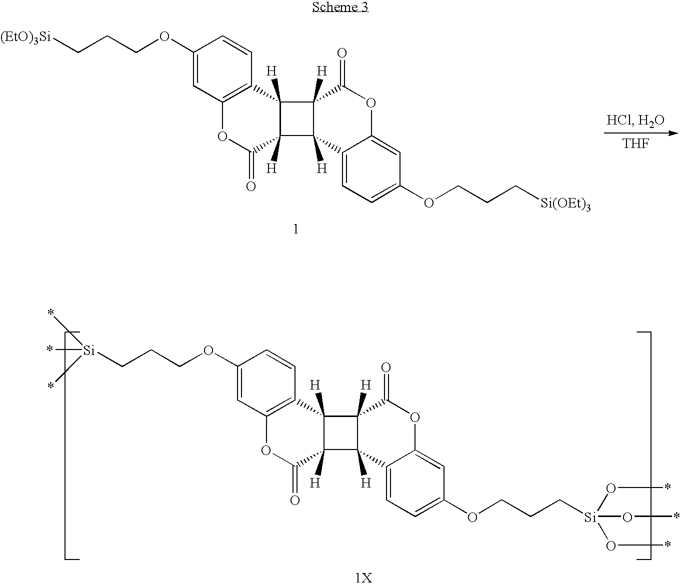

In an embodiment, 148.5 mg (0.2 mmol) of syn-head-to-tail-7-(3-triethoxysilyl)propyloxycoumarin dimer 1 was added along with THF (0.2 mL) to a 5 mL scintillation vial, to which was then added aqueous HCl (20 μL, 1N). The resulting mixture was shaken, capped, and allowed to stand at room temperature to gel. Within 24 hours, a transparent, colorless monolithic gel (represented in Scheme 3 by polymeric structure 1X) had formed. The resulting gel was slowly dried at room temperature for at least 10 days to afford a monolithic transparent xerogel. For thin film preparation, the sol was allowed to stand at room temperature for 12 hours, and then cast on substrates by spin-coating. Thin films were prebaked at 70° C. for 2 hours. Photopatteming was conducted when thin films were directly contacted with a photomask and exposed to ultraviolet light of 254 nm.

Powder XRDs of the dried xerogels are consistent with amorphous materials. TEM images show little contrast with no discernable structure above 10 Å and no evidence of phase separation of organic and inorganic components. Dried xerogels of 1 are colorless, transparent, hard materials that are thermally robust; the onset of weight loss, which does not occur until approximately 300° C., is characteristic of this family of hybrid materials [Shea, K., & Loy, D., Bridged polysilsesquioxanes: Molecular engineering of hybrid organic-inorganic materials, Mrs. Bull. 26, 368-376 (2001); Shea, K., Loy, D., & Webster, O., Arylsilsesquioxane Gels and Related Materials—New Hybrids of Organic and Inorganic Networks, J. Am. Chem. Soc. 114, 6700-6710 (1992)]. The xerogels are nonporous to nitrogen sorption indicating relatively compliant networks that collapse during drying. IR analysis (lactone diagnostic: 1750 cm⁻¹) reveals the bis-lactone substructure remains intact in the dried xerogel.

In another embodiment, a silyl substituent containing a single polymerizable site is used to prepare a linear silicone-like polymer (elastomer) according to the present invention. As shown below in Scheme 4, compound 1A is subjected to the reaction conditions described above regarding Scheme 3 to produce linear polymer 1Y.

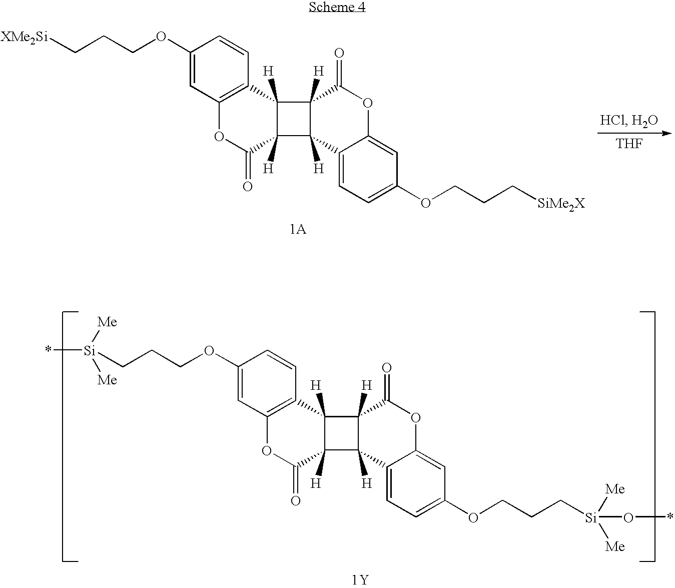

Syn-ht-photodimer may be prepared, as generally described above in Scheme 2 using as the silyl reagent SiHMe₂X, wherein “X” represents a reactive substituent such as, but not limited to, a halogen or alkoxy. The silyl substituent SiMe₂X merely represents one aspect of the general structure SiXₙR′ₘ described above regarding Scheme 2, wherein R′ is Me, m=2, and n=1. Of course, any silyl substituent SiXₙR′ₘ wherein m=2 and n=1 may be employed as shown in Scheme 4.

Monomers not comprising a silicon-containing substituent may also be utilized to produce photoresponsive polymers consistent with the present invention. As stated above with regard to the coumarins and the photodimers produced therefrom, R may comprise a substituent that does not contain silicon. Thus, the syn-ht-photodimer shown in Scheme 1 (or a 4- and/or 6-substituted analog thereof) may constitute a monomer suitable for polymerization consistent with the present invention. Specifically, where R comprises a polymerizable substituent including, but not limited to, (substituted or unsubstituted, cyclic or acyclic, aromatic or non-aromatic) alkenyl, alkynyl, acryl, a-halo carbonyl, or any carbon-containing moiety having at least one degree of chemical unsaturation, the coumarin photodimer may be employed in practicing the present invention. In such an embodiment, a syn-head-to-tail-7-methacrylcoumarin dimer may be polymerized to provide photoresponsive polymers as described by Scheme 5 below.

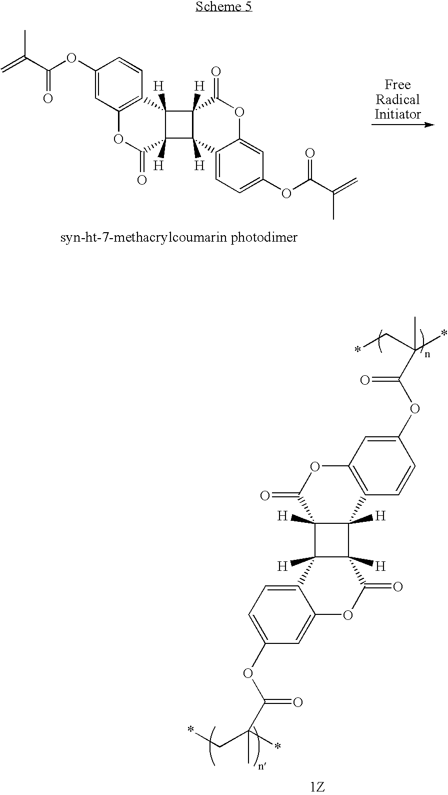

The syn-head-to-tail-7-methacrylcoumarin photodimer may be prepared according to the general method described above for the reaction shown in Scheme 1, where substituent “R” is H₂C═C(CH₃)—C(O)—. The photodimer may be polymerized by exposure under appropriate conditions to a free radical initiator to yield branched polymer 1Z. Free radical initiators useful in effecting the polymerization include, but are not limited to, 2,2′-azobisisobutyronitrile (AIBN), di-t-butyl peroxide, and benzoyl peroxide.

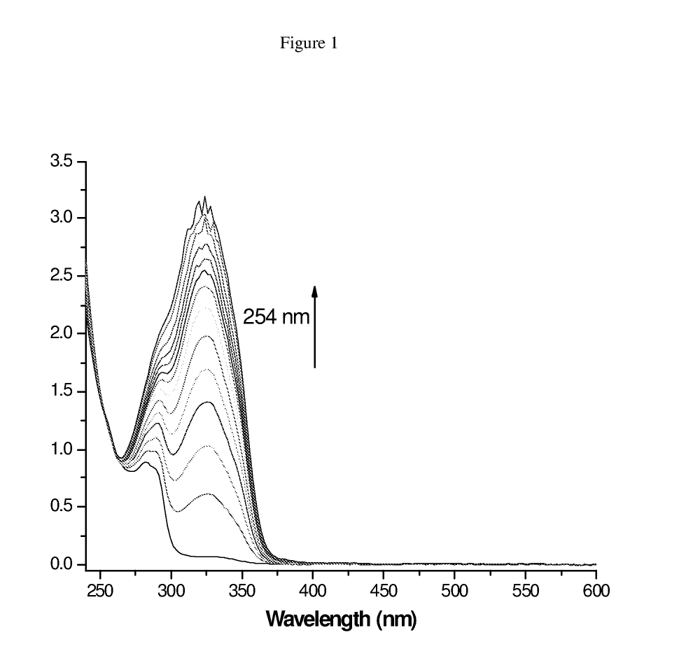

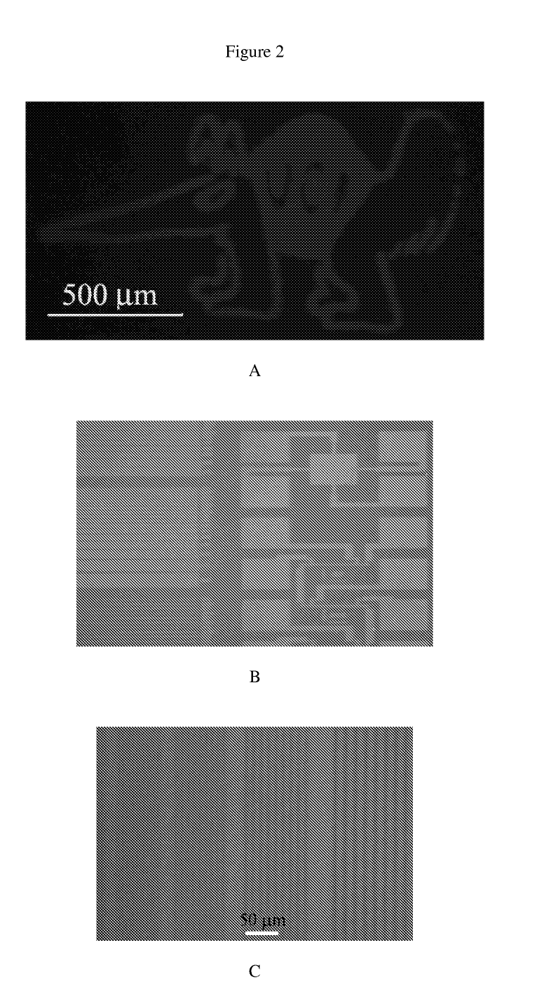

The photoresponse of compound 1X was probed using clear, colorless and transparent thin films (100 nm) cast by spin coating the sol of 1 (1M in THF) containing H₂O (6 equiv.) and HCl (0.1 equiv.) on quartz plates. Following annealing at 70° C., irradiation at short wavelengths (˜254 nm) produces no visible change; the film remains colorless and transparent. Interrogation by UV, however, reveals a new absorption at 328 nm (See FIG. 1) and an intense fluorescence emission at λ=390 nm. (See FIG. 2). The observed spectral change is consistent with radiation-induced cleavage of the photodimer to produce a pair of 7-alkyloxy coumarin fragments (Scheme 6).

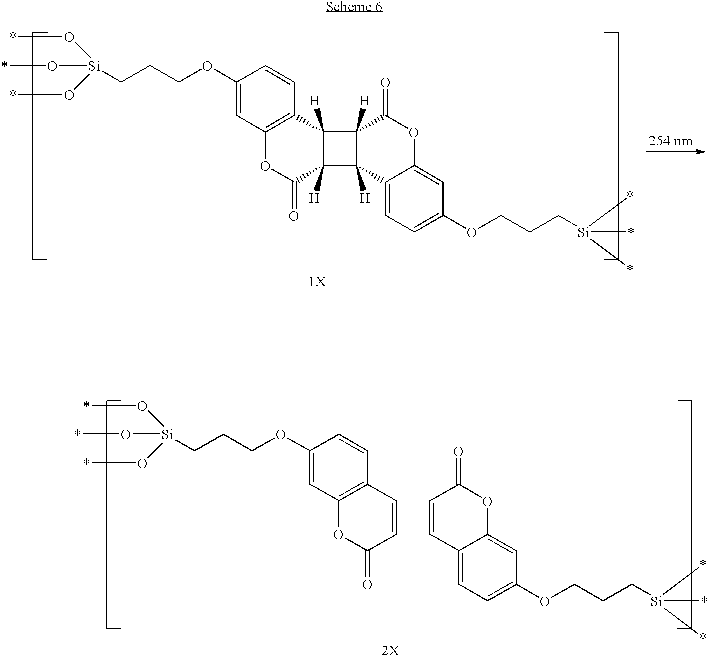

Photopatterning the sol-gel derived thin film with 254 nm light generates a bright fluorescent image of the photomask features against a “silent” background. The images in FIG. 2 provide examples. The patterns, which are not discerned under ambient illumination, are revealed by their fluorescence emission at 390 nm when excited at 350 nm. This feature has applications for secure recognition systems [Kishimura, A., Yamashita, T., Yamaguchi, K., & Aida, T., Rewritable phosphorescent paper by the control of competing kinetic and thermodynamic self-assembling events, Nat. Mater. 4, 546-549 (2005); Rose, A., Zhu, Z., Madigan, C., Swager, T., & Bulovic, V., Sensitivity gains in chemosensing by lasing action in organic polymers, Nature 434, 876-879 (2005)]. Importantly, the fluorescence images can be erased by irradiation at 324 nm. The erasure is attributed to the photodimerization of geminate pairs of 7-alkoxycoumarins that are held in proximity in the highly condensed polysilsesquioxane matrix. The photopatterning in FIG. 2 was achieved by direct contact of the photomask followed by irradiation with an 18 W UVG lamp with a wavelength of 254 nm.

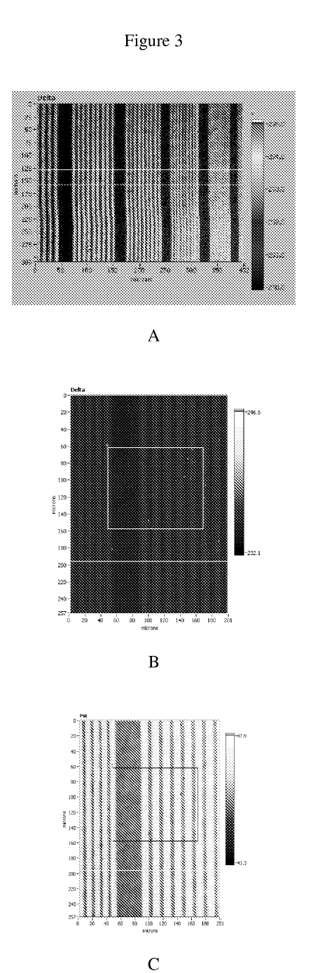

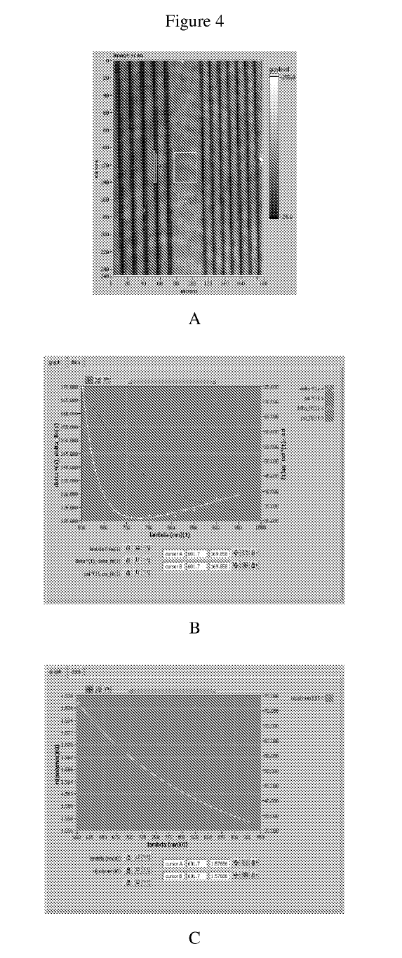

The absorption spectra of the coumarin-based monomer and photodimer differ substantially. In condensed photopatterned films this can lead to spatially resolved differences in the refractive index. Imaging spectroscopic ellipsometry on thin films of 1X cast on silicon wafers was used to interrogate the film. Ellipsometric studies afforded high lateral resolution maps (See FIGS. 3A-C) and 3D profiles of the refractive index and thickness (FIGS. 4A-C) of a section of the photopatterned films. The regions included features of the pattern from the photomask ranging in size from 8 to 0.8 μm. A Delta map (FIG. 3A) contains a region of the photopattern corresponding to strip widths of 6.0, 4.8, 4.0, 3.2, and 2.4 μm (reading left to right on the map, light areas corresponding to irradiated sections). A higher resolution Delta map (FIG. 3B) of a section of the pattern and the corresponding Psi-map (FIG. 3C) are also shown. The sharp contrast results from the difference in refractive index and thickness between irradiated and non-irradiated domains. The calculated refractive index difference between the irradiated and non-irradiated domains is 0.013 within the wavelength range from 600 nm to 900 nm.

FIG. 4A shows an ellipsometric contrast image of a photopatterned thin film of compound 1X on a silicon wafer substrate (top view, 53° angle of incidence at 532 nm wavelength). The ellipsometric Delta/Psi spectra are measured simultaneously in both regions of interest (ROIs, white frames). The signal of each ROI is averaged over the area of the ROI. FIG. 4B shows the spectra of Delta/Psi as a function of wavelength lambda recorded in ROI 1. The spectra and fitted data of ROI 0 look very similar and are therefore not shown. The data fitting is based on the optical model assuming one isotropic layer with extinction k=0. As stated previously regarding refractive index differences, FIG. 4C shows the refractive index n in ROI 0, which is according to the fit 0.013 lower than the n of ROI 1.

The dispersion of the refractive index of the film as a function of the wavelength λ follows the Cauchy function n(λ)=Aₙ+Bₙ/λ². Data fitting provided for the film thickness d and the parameters Aₙ and Bₙ. The best fits were obtained with d=111.2+0.6 nm, Aₙ=1.543±0.006, and Bₙ=12200±1700 for the non-irradiated area, and d=107.9±0.5, Aₙ=1.556±0.007, and Bₙ=12200±1700 for the irradiated area (See FIG. 4C). The Psi-map (FIG. 3C) has the same field of view as shown in FIG. 3B. Data were collected at 532 nm wavelength and a 53° angle of incidence.

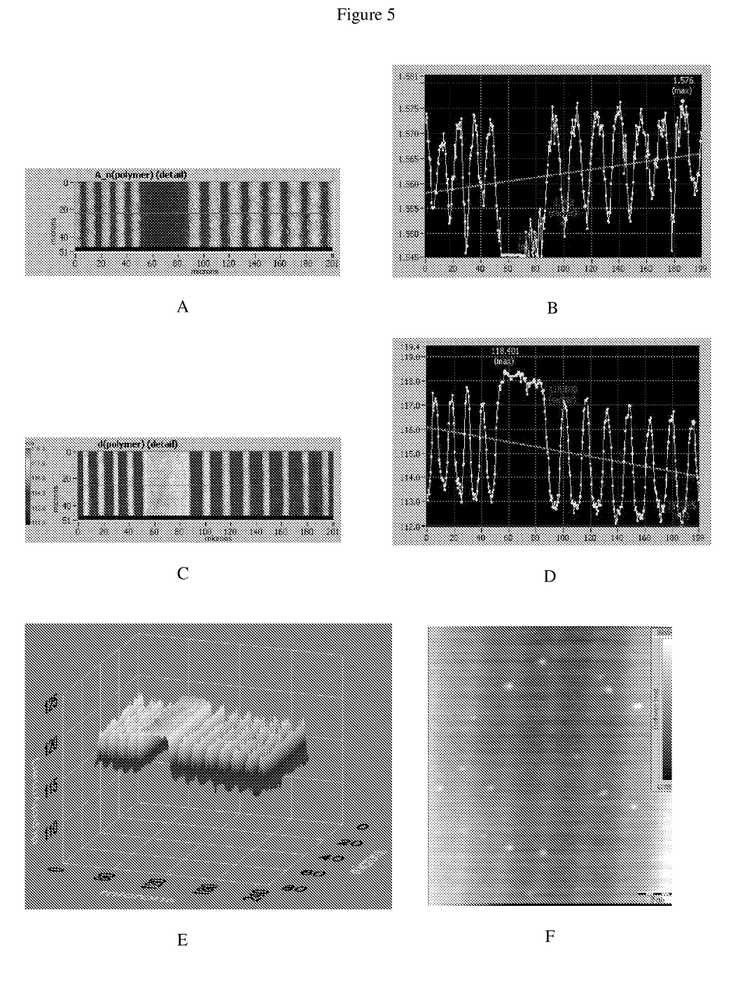

Further analysis of these data provides maps and profiles (FIGS. 5A-E) of refractive index and thickness of the corresponding photopattem from FIGS. 3B and 3C. FIGS. 5A and 5B arise from the significant positive change in refractive index between irradiated (light areas) and non-irradiated (dark areas) regions. Imaging ellipsometry also provides information about the variation in film thickness corresponding to features in the photopattern. A pattern of thickness variation of ˜3 nm between irradiated and non-irradiated areas is clearly revealed (FIGS. 5C-D). The slight collapse (˜3%) in film thickness of the irradiated domains may be explained by weakening the scaffold of the material by rupturing crosslinks in the silsesquioxane network. An analogy may be a sagging roof resulting from removal of supporting beams. A 3-dimensional profile of the topology from this data is shown in FIG. 5E. The topographical patterns (wide stripes) were confirmed by AFM (FIG. 5F). The spacing between stripes in the AFM-graph is 5 μm. This corresponds to the repeat distance determined by imaging ellipsometry (5 μm, as well as the photomask) and highlights the utility of imaging ellipsometry for topographical analysis over large areas. The degree of structural collapse will be dependent upon the duration and intensity of irradiation.

With regard to the photoresponsive materials described in this study derived from monomer 1, the use of lower loadings and shorter irradiation times would produce proportionately less collapse. The refractive index patterns of the photoresponsive bridged polysilsesquioxanes 1X are well suited for direct write technology. Irradiation produces domains of high refractive index surrounded by a low refractive index matrix. This is particularly relevant since the coumarin photodissociation is amenable to two photon processes (532 nm with cross sections of 1.6×10⁻⁵² cm⁴s photon⁻) [Kim, H., Kreiling, S., Greiner, A., & Hampp, N., Two-photon-induced cycloreversion reaction of coumarin photodimers, Chem. Phys. Lett. 372, 899-903 (2003)]. The readout of the refractive index patterns is completely nondestructive.

FIGS. 5A and 5B show the refractive index map and refractive index profile, respectively, of a section of the photopatterned compound 1X thin film. FIGS. 5C and 5D show the thickness map and thickness profile (1 μm lateral resolution), respectively, thereof. Both maps (5A and 5C) were calculated from the Delta and Psi maps of FIGS. 3B and 3C. For these calculations the Cauchy parameter Bₙ=12200 is fixed, while Aₙ and thickness d are fitted for each pair of Delta/Psi of each pixel in the field of view. FIG. 5E is a 3-dimensional thickness profile showing the field of view of map (FIG.) 5A on the patterned thin film. FIG. 5F is a thickness map of the strips recorded with AFM.

Attached hereto as Appendix A (A1-A13) is the following related manuscript: “An Optically Transparent Photoresponsive Hybrid Material for Direct Writing of Refractive Index and Fluorescent Patterns,” submitted for publication as a Communication in Nature Materials in October, 2005. Attached hereto as Appendix B (B1-B2) is the supporting material for this manuscript.

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A compound having the chemical formula 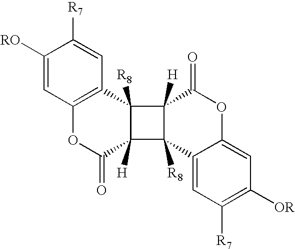
wherein:
R comprises a substituent selected from the group consisting of H and CR₁R₂R₃, wherein R₁, R₂, and R₃ comprise, independently;
H or cyclic or acyclic, substituted or unsubstituted, alkyl or aryl (or wherein the combination of R₁ and R₂ represents a substituted or unsubstituted alkene or imine, or a cyclic moiety, or wherein the combination of R₁, R₂, and R₃ represents cyanide, an alkyne, or a bi-cyclic moiety);
NR₄R₅, wherein R₄ and R₅ comprise, independently, H, cyclic or acyclic, substituted or unsubstituted, alkyl or aryl (or wherein the combination of R₄ and R₅ represents a cyclic moiety containing N or a substituent double-bonded to N), or
OR₆, wherein R₆ comprises H, cyclic or acyclic, substituted or unsubstituted, alkyl or aryl; and
R₇ and R₈ comprise, independently, substituents selected from the group consisting of:
H;
halogen;
CR_{1′}R_{2′}R_{3′}, wherein R_{1′}, R_{2′}, and R₃ comprise, independently, H, cyclic or acyclic, substituted or unsubstituted, alkyl or aryl (or wherein the combination of R_{1′} and R_{2′} represents a substituted or unsubstituted alkene or imine, or a cyclic moiety, or wherein the combination of R_{1′}, R_{2′}, and R_{3′} represents cyanide, an alkyne, or a bi-cyclic moiety), NR_{4′}R_{5′}, wherein R_{4′} and R_{5′} comprise, independently, H, cyclic or acyclic, substituted or unsubstituted, alkyl or aryl (or wherein the combination of R_{4′} and R_{5′} represents a cyclic moiety containing N or a substituent double-bonded to N), and OR_{6′}, wherein R_{6′} comprises H, cyclic or acyclic, substituted or unsubstituted, alkyl or aryl;
NR₉R₁₀, wherein R₉ and R₁₀ comprise, independently, H or cyclic or acyclic, substituted or unsubstituted, alkyl or aryl, (or wherein the combination of R₉ and R₁₀ represents a cyclic moiety containing N or a substituent double-bonded to N); and
OR₁₁, wherein R₁₁ comprises H or cyclic or acyclic, substituted or unsubstituted, alkyl or aryl.

2. A compound having the chemical formula 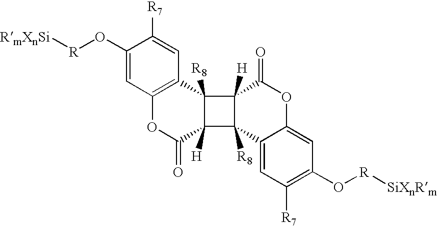
wherein:
R comprises CR₁R₂R₃, wherein R₁, R₂, and R₃ comprise, independently, substituents selected from the group consisting of:
H, cyclic or acyclic, substituted or unsubstituted, alkyl or aryl (or wherein the combination of R₁ and R₂ represents a substituted or unsubstituted alkene or imine, or a cyclic moiety, or wherein the combination of R₁, R₂, and R₃ represents cyanide, an alkyne, or a bi-cyclic moiety);
NR₄R₅, wherein R₄ and R₅ comprise, independently, H, cyclic or acyclic, substituted or unsubstituted, alkyl or aryl (or wherein the combination of R₄ and R₅ represents a cyclic moiety containing N or a substituent double-bonded to N), and
OR₆, wherein R₆ comprises H, cyclic or acyclic, substituted or unsubstituted, alkyl or aryl;
R₇ and R₈ comprise, independently, substituents selected from the group consisting of:
H;
halogen;
CR_{1′}R_{2′}R_{3′}, wherein R_{1′},R_{2′}, and R_{3′} comprise, independently, cyclic or acyclic, substituted or unsubstituted, alkyl or aryl (or wherein the combination of R_{1′}, R_{2′}, and R_{3′} represents cyanide, an alkyne, or a substituted or unsubstituted alkene or imine, or a cyclic or bi-cyclic moiety), NR_{4′}R_{5′}, wherein R_{4′} and R_{5′} comprise, independently, H, cyclic or acyclic, substituted or unsubstituted, alkyl or aryl (or wherein the combination of R_{4′} and R_{5′} represents a cyclic moiety containing N or a substituent double-bonded to N), and OR_{6′}, wherein R_{6′} may comprise substituents including, but not limited to, H, cyclic or acyclic, substituted or unsubstituted, alkyl or aryl;
NR₉R₁₀, wherein R₉ and R₁₀ comprise, independently, H or cyclic or acyclic, substituted or unsubstituted, alkyl or aryl, (or wherein the combination of R₉ and R₁₀ represents a cyclic moiety containing N or a substituent double-bonded to N); and
OR₁₁, wherein R₁₁ comprises H or cyclic or acyclic, substituted or unsubstituted, alkyl or aryl;
X comprises, independently, substituents selected from the group consisting of:
halogen;
cyclic or acyclic, substituted or unsubstituted, alkyl or aryl carbon-containing moiety comprising at least one non-aromatic sp² or sp hybridized carbon; and
OR″, wherein R″ comprises H and cyclic or acyclic, substituted or unsubstituted, alkyl or aryl (or wherein the combination of two X substituents represents a cyclic moiety, or wherein the combination of three X substituents represents a bi-cyclic moiety); and
R′ comprises, independently, a substituent selected from the group consisting of:
H;
cyclic or acyclic, substituted or unsubstituted, alkyl or aryl (or wherein the combination of two R′ substituents represents a cyclic moiety, or wherein the combination of three R′ substituents represents a bi-cyclic moiety) (or wherein the combination of an X substituent and an R′ substituent represents a cyclic moiety, or wherein the combination of two X substituent and an R′ substituent or the combination of an X substituent and two R′ substituents represents a bi-cyclic moiety);
wherein n represents an integer from 1 to 3, and m represents an integer from 0 to 2, wherein n+m=3.

3. A composition of matter produced by polymerization of the compound of claim 1, wherein R comprises at least one non-aromatic sp or sp hybridized carbon.

4. A method for preparing a composition of matter comprising polymerizing the compound of claim 1, wherein R comprises at least one non-aromatic sp² or sp hybridized carbon.

5. A composition of matter produced by the reaction of the compound of claim 2 and an acid.

6. A method for preparing a composition of matter comprising reacting the compound of claim 2 with an acid.
